(19) United States
(12) Patent Application Publication
(10) Pub. No.: US 2024/0394800 A1
(43) Pub. Date: Nov. 28, 2024

(54) QUOTE-TO-ISSUE DIGITAL TRANSACTION SYSTEM

(71) Applicant: Goosehead Financial, LLC, Westlake, TX (US)

(72) Inventors: Brian Pattillo, Westlake, TX (US); Casey Bomar, Westlake, TX (US); Sarai Dominguez, Westlake, TX (US)

(21) Appl. No.: 18/597,672

(22) Filed: Mar. 6, 2024

Related U.S. Application Data
(60) Provisional application No. 63/488,754, filed on Mar. 6, 2023.

(51) Int. Cl. G06Q 40/08; G06Q 20/12; G06Q 20/40

(52) U.S. Cl. CPC G06Q 40/08; G06Q 20/12; G06Q 20/401

(57) ABSTRACT

Methods and systems herein are provided for processing a digital transaction to bind and to issue an insurance policy. A confirmation page is displayed on a graphical user interface for a user to confirm or edit coverage details. Upon receiving confirmation of the coverage details, the insurance quote is recalculated, via an application programming interface (API), based on the confirmed coverage details and the mortgage information. A payment screen is displayed for the user to select a payment method. Upon selection of a payment method, generating a payment token based on the entered payment details. The recalculated quote is sent, via the API, for binding the insurance policy. A policy number is received from an insurance provider system and stored in a database. Customer relationship management (CRM) data with the policy information, such as property, driver, vehicle details, the policy number, and the bound status of the insurance policy.

### CROSS-REFERENCE TO RELATED APPLICATIONS

This application claims the benefit of U.S. Provisional Application Ser. No. 63/488,754, filed Mar. 6, 2023, and entitled “quote-to-Issue digital TRANSACTION system,” which is hereby incorporated by reference for all purposes.

### BACKGROUND

This application relates to digital transactions for binding insurance policies.

Applying for insurance may be an involved process. It includes providing demographic information, driving records, and other information. It can also be a slow process. After deciding on what to insure, applicants may select one or more insurance carriers. Because insurers may not evaluate the same criteria, they may require different information.

The assessment of an applicant may be subjective. It is common for an applicant to receive different rates, different coverage levels, and different terms from different insurers. Current systems do not allow users to electronically complete policy issuance after receiving, compare, and/or accepting multicarrier quotes. In other words, current systems do not provide a semi-automated or automated system that binds insurance products after a user's acceptance of the quoted policy in the absence of live agent intervention.

### SUMMARY

Aspects of the invention will be apparent from the following description and the appended claims.

### BRIEF DESCRIPTION OF DRAWINGS

FIG. 1 shows a computing environment in accordance with one or more embodiments of the invention.

FIG. 2 shows a block diagram of a quote-to-issue application in accordance with one or more embodiments of the invention.

FIGS. 3A and 3B show a system flow diagram in accordance with one or more embodiments of the invention.

FIG. 4 is a first page of a progressive graphical user interface in accordance with one or more embodiments of the invention.

FIG. 4 is a first page of a progressive graphical user interface in accordance with one or more embodiments of the invention.

FIG. 5 shows another page of a progressive graphical user interface in accordance with one or more embodiments of the invention.

FIG. 6 shows another page of a progressive graphical user interface in accordance with one or more embodiments of the invention.

FIG. 7 shows another page of a progressive graphical user interface in accordance with one or more embodiments of the invention.

FIG. 8 shows another page of a progressive graphical user interface in accordance with one or more embodiments of the invention.

FIG. 9 shows another page of a progressive graphical user interface in accordance with one or more embodiments of the invention.

FIG. 10 shows another page of a progressive graphical user interface in accordance with one or more embodiments of the invention.

FIG. 11 shows another page of a progressive graphical user interface in accordance with one or more embodiments of the invention.

FIG. 12 shows another page of a progressive graphical user interface in accordance with one or more embodiments of the invention.

FIG. 13 shows another page of a progressive graphical user interface in accordance with one or more embodiments of the invention.

FIG. 14 shows another page of a progressive graphical user interface in accordance with one or more embodiments of the invention.

FIG. 15 shows another page of a progressive graphical user interface in accordance with one or more embodiments of the invention.

FIG. 16 shows another page of a progressive graphical user interface in accordance with one or more embodiments of the invention.

FIG. 17 shows another page of a progressive graphical user interface in accordance with one or more embodiments of the invention.

FIG. 18 shows another page of a progressive graphical user interface in accordance with one or more embodiments of the invention.

FIG. 19 shows another page of a progressive graphical user interface in accordance with one or more embodiments of the invention.

FIG. 20 shows another page of a progressive graphical user interface in accordance with one or more embodiments of the invention.

FIG. 21 shows another page of a progressive graphical user interface in accordance with one or more embodiments of the invention.

FIG. 22 shows another page of a progressive graphical user interface in accordance with one or more embodiments of the invention.

FIG. 23 shows another page of a progressive graphical user interface in accordance with one or more embodiments of the invention.

FIG. 24 shows another page of a progressive graphical user interface in accordance with one or more embodiments of the invention.

FIG. 25 shows a flow chart in accordance with one or more embodiments of the invention.

FIGS. 26A and 26B show a computing system in accordance with one or more embodiments of the invention.

Like elements in the various figures are denoted by like reference numerals for consistency.

### DETAILED DESCRIPTION

In general, embodiments are directed to a computer system for issuing digital transactions to bind insurance policies.

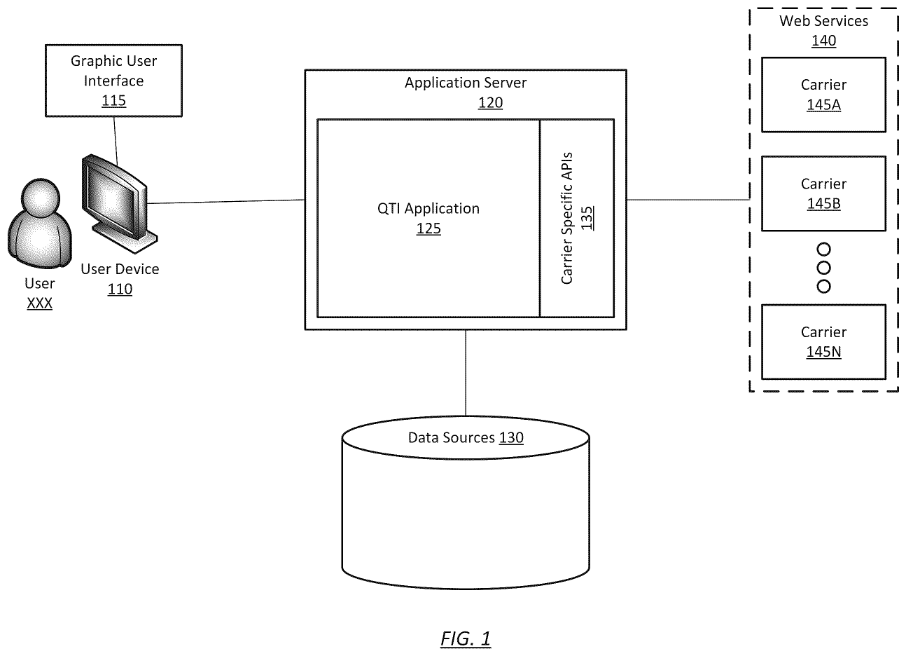

FIG. 1 is a computing environment according to illustrative embodiments. The computing environment of FIG. 1 provides an insurance quoting and sales system that enables users of client device (110) to obtain insurance product offerings from multiple third-party vendors that provide insurance or may be associated with providing insurance. The client device (110) may be for example, a mobile device, wireless device, local or remote stand-alone desktop or portable computer or controller that may execute various computer applications.

The client device (110) may access a front-end application server (120) communicating with a number of back-end data sources (130) and web services (140). Either or both of the client device (110) or application server (120) may store, and format user submitted information, either temporarily or permanently, to efficiently obtained information from web services (140) while reducing the amount of data entry required in a quoting process.

The client device may include a graphical user interface (GUI) (115) that utilizes a progressive disclosure interaction design pattern. The progressive disclosure of GUI (115) sequences information and actions across several screens as the user progresses through information submission and receipt for binding an insurance policy after receiving quotes from the various web services (140). By disclosing information progressively, the GUI (115) reveals only the as-needed essentials, helping users manage the complexity of feature-rich websites or applications and lowering the chances that users will feel overwhelmed by the transaction.

The GUI (115) interacts with logic of the quote-to-issue (QTI) system (125). in one illustrative use case, QTI system (125) is configured to issue and bind insurance product offerings, such as home or automobile insurance, after receiving a quote from an insurance carrier. In this illustrative example, QTI application (125) can be run in a remote location on application server (120). In another illustrative example, QTI application (125) can run on client device (110) and can take the form of a system instance of the application. In yet other illustrative examples, QTI application (125) can be distributed in multiple locations across a network of computer systems. For example, QTI application (125) can run on client device (110) and application server (120) depending on the particular implementation.

Issuing an insurance policy typically requires the sequential occurrence of several steps. For example:

Application: The policyholder applies for coverage to the insurance company. The application typically includes information about the policyholder's personal and financial information, as well as details about the type of coverage being applied for.

Underwriting: The insurance company reviews the application and conducts an underwriting process to determine the policyholder's risk profile and whether they are eligible for coverage. This process may include a review of the policyholder's credit score, medical history, and other relevant information. Based on this information, the insurance company will provide the policyholder with a quote for the coverage.

Premium quote: Once the underwriting process is complete, the insurance company will provide the policyholder with a premium quote, which is the cost of the coverage. Once the quote has been issued, the policyholder can review the coverage options and decide if they would like to add any riders or endorsements to their policy. These additional coverage options or discounts can be added as a rider or endorsement to the policy, which will then be reviewed and approved by the insurance company. The policyholder will have the option to accept or decline the quote.

Policy options can be added as a rider or endorsement to an existing insurance policy. Both an endorsement and a rider are both types of documents that can be used to add or modify coverage in an insurance policy. However, the terms are often used interchangeably, and the exact definition of each term may vary depending on the context and the insurance company.

An endorsement is a document that amends or adds to the terms of an existing insurance policy. It is used to amend coverage, add, or remove coverage, or make other adjustments to the policy. An endorsement is attached to the original policy, and it becomes a part of the policy.

A policy endorsement amends or adds to the terms of an existing insurance policy. It is used to amend coverage, add, or remove coverage, or make other adjustments to the policy. Policy endorsements are typically used to add coverage for specific risks or situations that were not included in the original policy, or to adjust the policy to reflect a change in the policyholder's circumstances.

A rider can be used to add coverage for specific risks or situations that were not included in the original policy, or to adjust the policy to reflect a change in the policyholder's circumstances. Once approved, the policyholder may be required to pay an additional premium for the riders added.

Acceptance: If the policyholder accepts the premium quote, they will be required to pay the first premium in order to bind the policy. Binding an insurance policy means that the policy is in effect and the insurance company is obligated to provide coverage according to the terms of the policy. Once a policy is bound, the insurance company is required to pay claims that are covered under the policy, subject to any exclusions or limitations. Binding typically occurs after the policyholder has applied for coverage, the insurance company has reviewed the application and determined that the policyholder is eligible for coverage, and the policyholder has paid the first premium.

Binding refers to the process of making the policy legally effective. binding an insurance policy is similar to the execution of a contract. An insurance policy is a contract between the insurance company and the policyholder, in which the insurance company agrees to provide coverage in exchange for the policyholder paying premiums. Binding the policy signifies that both parties have agreed to the terms of the contract and are legally bound to fulfill their respective obligations. The insurance company is obligated to provide coverage as outlined in the policy, and the policyholder is obligated to pay the premiums.

Policy issuance: Once the first premium is paid, the insurance company will issue a policy, which will include all the details of the coverage and the terms of the contract. This signifies that the policy is now bound and both parties are legally bound to fulfill their respective obligations. Issuance refers to the process of creating and providing the policyholder with a physical or digital copy of the policy document. This document contains all the details of the coverage, including the policyholder's personal information, coverage limits, exclusions, and other valuable information. The policy is considered issued once the policyholder receives a copy of the policy.

The GUI (115) interacts with logic of the quote-to-issue (QTI) system (125). GUI (115) is A progressive graphical user interface (GUI) is a type of interface that guides users through a series of steps or tasks in a specific order. This type of interface is often used in software applications to guide users through complex processes or tasks that require multiple steps. The interface is typically organized as a series of screens or pages, with the user moving from one screen to the next in a linear fashion. Each screen or page presents the user with a specific task or set of options, and the user must complete or select one before moving on to the next. A progressive GUI may also be referred to as a sequential GUI, a linear GUI, linear flow GUI, step-by-step GUI, or wizard.

As compared to a regular (or non-sequential) GUI, the sequential design of GUI (115) offers several benefits. For example:

In some embodiments, the GUI (115) simplifies the user experience by breaking down a complex process or task into smaller, manageable steps. This simplicity enables users to understand and complete tasks more easily and with less confusion.

In some embodiments, the linear structure of GUI (115) provides clear guidance for users. The clarity provided by GUI (115) may enable more apparent understanding of where users are in the quote-to-issue process, and the next steps in the process.

In some embodiments, by guiding users through a process step by step, GUI (115) can help prevent errors by ensuring that the user completes all necessary steps and enters all necessary information.

In some embodiments, the GUI (115) can make it faster and easier for users to accomplish a task by providing clear guidance and reducing the need for users to navigate through multiple screens or options.

In some embodiments, the GUI (115) can be especially useful for onboarding new users, as it guides them through the process of getting started with a new software or app.

In some embodiments, the GUI (115) is easier to learn and use than a regular GUI, as the linear structure makes it easier for users to understand the flow and structure of the interface.

In some illustrative embodiments, QTI application (125) may utilizes a microservices event-based architecture. A microservices architecture is a software design pattern that structures an application as a collection of loosely coupled, small, independent services. Each microservice is designed to perform a specific business function and can be deployed and executed independently of other services. This allows for greater flexibility, scalability, and maintainability compared to a monolithic architecture, where an application is built as a single, tightly coupled entity.

When a microservices architecture is utilized, QTI application (125) may enable GUI (115) to resolve one or more difficulties in creating a sequential GUI for binding online insurance, such as:

In some embodiments, the state management: QTI application (125) enables GUI (115) to manage the state of the interface, such as which step the user is currently on and what information has been entered.

In some embodiments, the GUI (115) to ensure that the user can easily move between steps in the binding process of the QTI application (125), providing clear feedback on the user's progress.

In some embodiments, the QTI application (125) enables GUI (115) to validate user input as the user progresses through the steps, considering different validation rules for different steps.

In some embodiments, the QTI application (125) enables GUI (115) to be more flexible than other progressive interfaces, as it guides the user through a set sequence of steps. the microservices architecture may enable developers more easily to amend the interface or add new features later on.

In one or more embodiments, GUI (115) solves one or more problems of prior GUI devices and sequential GUI devices, in the context of computerized insurance transactions, relating to one or more of state management, navigation, validation, flexibility, error handling, and testing.

For example, the different microservices of QTI application (125) may communicate with each other through APIs or messaging systems, with each service being responsible for its own data storage. This enables different carrier specific APIs (135) to be developed and deployed independently, using different programming languages, frameworks, and databases as needed.

Rather than reciting a mathematical algorithm, a fundamental economic or longstanding commercial practice, or a challenge in business, GUI (115) improves on existing interface devices that do not have a pre-electronic analog. The embodiments of GUI (115) provide significantly more than prior graphical user interface devices that merely allow for setting, displaying, and selecting data or information that is visible on a GUI. Instead, GUI (115) utilizes a specific, structured interface directly related a prescribed functionality that resolves a specifically identified problem of binding online insurance quotes.

Furthermore, the specific structure and concordant functionality of GUI (115) distinguishes this system as compared to conventional computer implementations of known procedures. The function of GUI (115) is not simply the generalized use of client device (110) as a tool to conduct a known or obvious process. Instead, GUI (115) provides an inventive concept that allows users to bind insurance products from different web services (140) more efficiently and accurately after a user's acceptance of the quoted policy in the absence of live agent intervention. Rather than the routine or conventional use of computers or the Internet, GUI (115) overcomes problems that are necessarily rooted in computer technology and that specifically arise in the realm of computer networks and user interfaces, resulting in an improvement to the capabilities of the computer system.

Application server (120) may retrieve information from one or more third-party data sources (130) to prefill or autosuggest data to the client device (110) to populate one or more input fields (e.g., templates, online applications, forms, etc.) that may be transmitted to the QTI application (125). Information retrieved from data sources (130) may also be submitted from application server to various web services (140) via one or more application programming interfaces (APIs) to obtain an insurance quote from one or more carriers.

Web services (140) may be associated with providing insurance service by one or more third-party vendors. Web services (140) may use the information submitted by the user to client device (110) to make underwriting decisions regarding insurance policies and rates. Upon receiving the information from application server (120), web services (140) may be configured to provide a quote for an insurance policy. Demographic, insurance, financial, and/or other data from a user and/or third-party data sources may be quantified by the system (e.g., in some cases, translated into numerical values, ratings, or scores based on a numerical point scale) to determine the viability or likelihood a user may qualify and/or may accept an offer of insurance from one or more insurance carriers.

Different carriers (145A-145N), corresponding to different web services (140), may require different data for generating a quote and issuing a policy thereafter. Gathering and submitting this data is often a collaborative process with each carrier. For example, while not required by most carriers, one integration may require a driver's license number for the purposes of returning the quotes, and may not return quotes without the requisite information. The QTI application (125) may utilize custom APIs having implementation specific endpoints that are directly integrated with the web services (140).

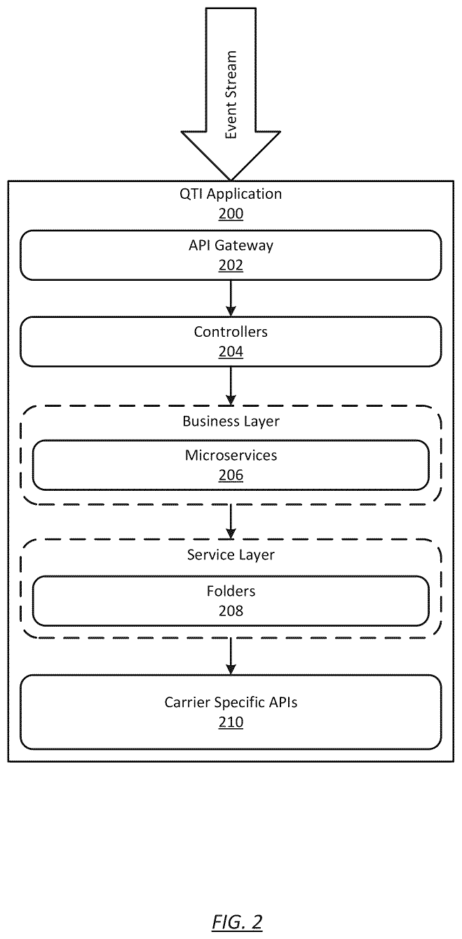

Referring now to FIG. 2, a block diagram of a quote-to-issue application is shown according to illustrative embodiments. QTI application (200) is an example of FIG. 1.

The QTI application (200) is a system configured to receive an event stream, index the events for storage and retrieval, and send the events to microservices (206). An event is a discrete portion of machine data that is associated with a timestamp. The events are transmitted by forwarders to indexers where the events are indexed and then provided to one or more microservices (206).

API gateway (202) acts as an intermediary between an application and a set of microservices. The API gateway (202) provides an entry point for external consumers (such as mobile applications or third-party systems) to access the microservices (206) that make up QTI application (200). API gateway (202) is responsible for request routing, composition, and protocol translation, among other things. In some embodiments, API gateway may provide additional features such as security, load balancing, and traffic management.

QTI application (200) includes one or more controllers (204), each corresponding to a separate set of products or services, implemented by one or more sets of microservices (206). Each microservices controller can be implemented as a separate component or as part of an API gateway (202). Its main purpose is to manage the flow of requests between microservices (206) and to ensure that the desired outcome is achieved, performing tasks such as load balancing, request routing, and service discovery.

Each of microservices (206) includes a file system, whereby files are contained in respective folders (208). A folder may be contained in other folders as in a tree structure. Events may be stored in folders (208) may be stored in sequential order or timestamp order in the file, whereby events that have a later timestamp are after events having an earlier timestamp. Events directed to a common set of microservices are stored in the same folder.

In one or more embodiments, the various folders (208) may comprise a message queue, implemented as a microservice, and subscribed to one or more microservices (206). Each message queue may include functionality for temporarily storing event messages. For example, the message queue may store the event messages as a sequential collection in a first-in-first-out (FIFO) data structure.

The QTI application (200) includes carrier specific APIs (210) having implementation specific endpoints that are directly integrated with the web services for the different carriers. APIs for these direct integrations are built to issue a policy return after receiving an initial quote.

In one or more examples, QTI application (200) integrates with applications and services deployed outside of the data platform. For example, QTI application (200) may expose a set of RESTful APIs for publishing and consuming service status messages that are compliant with QTI application (200) for each stage of a workflow.

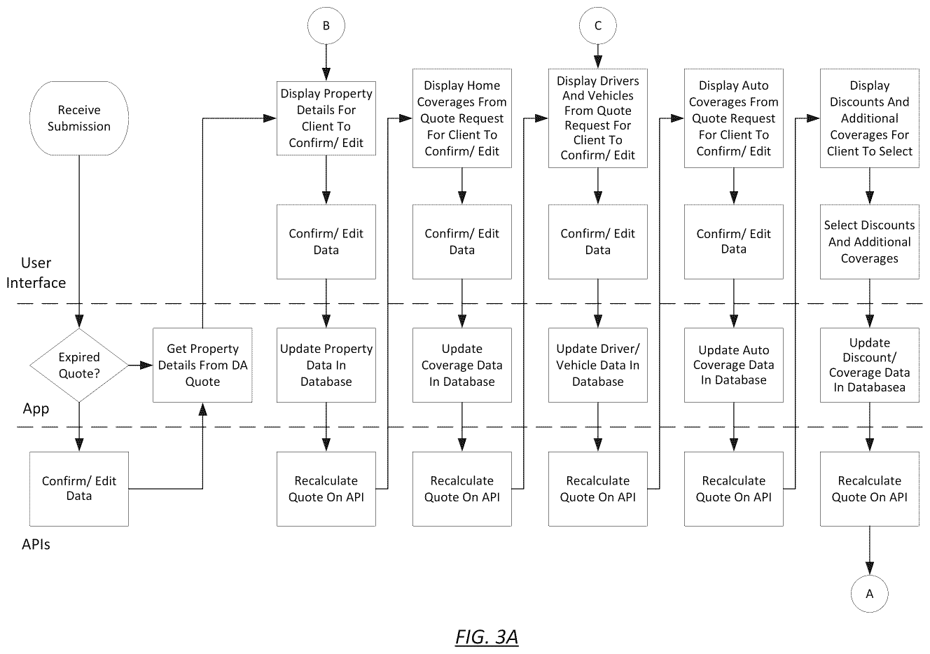

Referring now to FIG. 3, system flow diagram is shown according to illustrative embodiments. These system flow of FIG. 3 illustrates data flowing between the different components of QTI application (100) of FIG. 1.

The dataflow shown illustrated in FIG. 3 may utilize a Salesforce back-end using Heroku React Node.JS and a PostgreSQL database. Information is pulled from Salesforce and the logic in the app is applying before sending the information out to a MuleSoft integration platform. Carrier responses are sent back to the data platform where they synchronized with the local database, backed-up to Salesforce, and displayed in the user interface.

The dashed lines may represent boundaries between different systems or layers of the application, including the User Interface, the underlying App logic, APIs for external data and services, a CRM system, and a Payment processing system. The flowchart outlines a sequence of UI interactions, backend processes, and data updates that take place from the point of insurance confirmation to the binding of the policy and processing of the payment.

The complexities illustrated in FIG. 3 are compounded when the dataflow is scaled upwards to work with hundreds of carriers integrated onto the platform. Each of the carriers may work differently, using carrier-specific APIs that may require different or missing information.

Referring now specifically to FIG. 3A, the process starts when the system receives a submission, which could be a request issue a policy from an insurance quote. The app checks if the current quote has expired. If the quote is not expired, property details are retrieved from the quote. Otherwise, an API call is made to provide a current quote based on any updated information.

In the User Interface Section, asset details are displayed for confirmation and/or editing. Discounts and additional coverage options may also be presented to the client for selection.

For real property, Property Details are retrieved from the quote, and are displayed for the client to confirm or edit. Home insurance coverages retrieved from a quote request are displayed for the client's review and editing.

For automobile coverage, Driver and vehicle information from the quote request are shown for confirmation or editing. Auto insurance coverages from the quote request are displayed for client action.

In the App Section any updates made through the user interface are stored in the system's database. The property data in the system's database is updated based on the edits made by the client. Similarly, updates may be made to the home, driver/vehicle, and auto coverage data in the database based on the edits made by the client as well as updates discount and additional coverage data.

After each set of data is updated in the database, the quote is recalculated using an API, possibly to provide the most current quote based on the latest information.

Continuing at FIG. 3B, The User Interface (UI) displays a confirmation page where the client can review their coverage selections. The client is asked to confirm or edit their coverage details. If they choose to edit, the flow returns to the point where they can make changes (B) or (C).

Upon the client confirming their coverage, the UI then shows the payment screen. The client selects a payment method.

In some embodiments, payment may be made in connection with a mortgage secured by the real property. The client confirms or edits their mortgage information and the payment details. The system pulls mortgage information via an API, which could be used for finalizing the insurance details or for record-keeping.

In some embodiments, payment may be made using a credit card: The client enters credit card details and confirms payment, which triggers the next steps in the App and API layers. The quote may be recalculated through an API, possibly to ensure the final payment amount is correct.

The API is used again to send the recalculated quote and bind the insurance policy, which is a commitment that the insurance is in effect. The insurance provider sends a policy number which is then stored in the system's database.

Updates to the Customer Relationship Management (CRM) system are made, including the policy number and the status of the policy, indicating it is now bound. For automobile policies, Further updates to the CRM may include the new policy and associated property, driver, and vehicle information.

In the Payment section, a payment token with the payment details is generated, for secure processing of the payment transaction.

While FIGS. 1-3 shows a configuration of components, other configurations may be used without departing from the scope of the invention. For example, various components may be combined to create a single component. As another example, the functionality performed by a single component may be performed by two or more components.

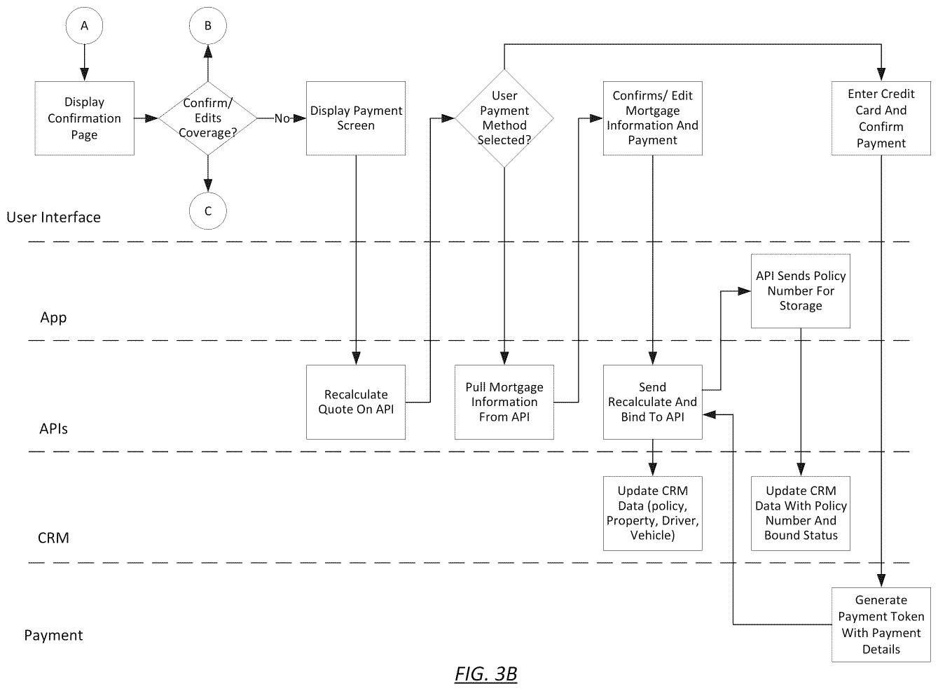

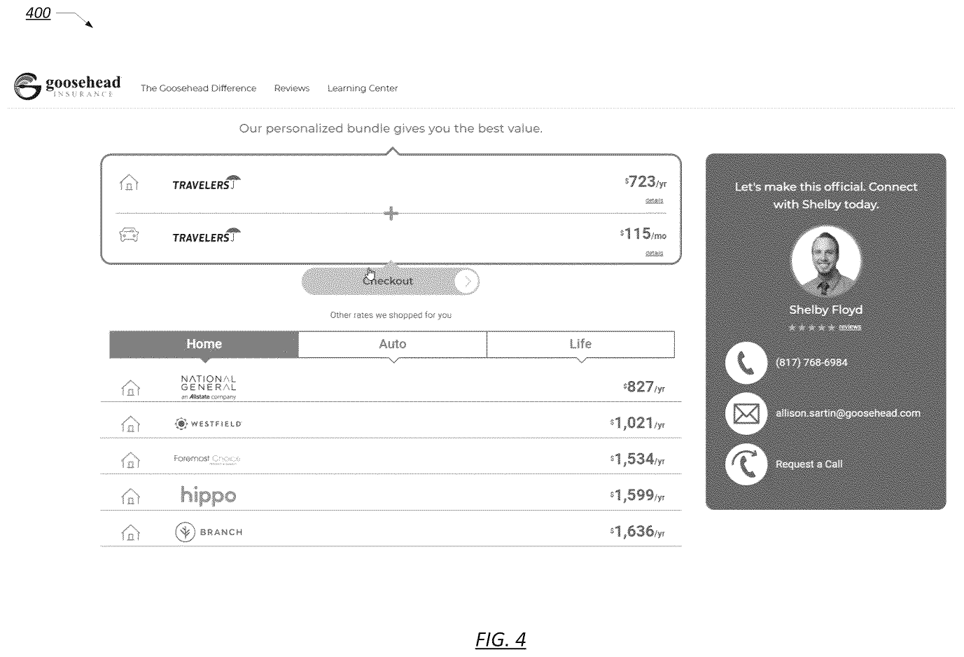

Collectively, FIGS. 4-24 illustrate pages of a progressive graphical user interface enabling quote-to-issue electronic transactions according to illustrative embodiments.

FIG. 4 is a first page of a progressive graphical user interface. Page (400) may display a set of quotes from one or more different carriers for one or more policies, such as home and auto insurance. Additionally, an element displaying a bundle of two or more different policies can be displayed as a recommended option. The recommendation can be based on, for example, policy costs, coverage options, or discounts that are available from the carrier when corresponding policies are bundled.

As depicted on the page (400), a single carrier have been selected as the best bundled option. In other embodiments, a combination of different carriers may be selected as providing the lowest cost based on the user's information, changing the quoted products. For each carrier, quotes are run under both individual and bundled scenarios. Logic provided, for example within the QTI application (125) of FIG. 1, mixes and matches combinations of quotes from the different carriers behind the scenes to determine a suggested option.

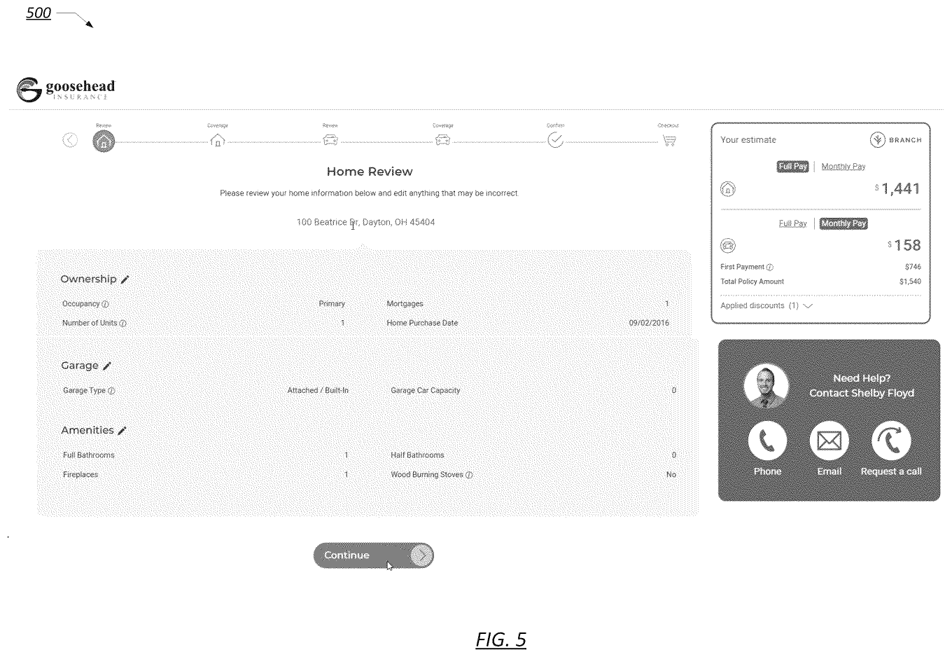

FIG. 5 is a second page of the progressive graphical user interface of FIG. 3. Information pulled from a third-party data source, such as one of data sources (130) of FIG. 1, is populated into the various fields of page (500). As illustrated, the information is about a user's home. Any updates that are potentially needed can be edited by the user. Selecting a field enables the user to edit the retrieved information, updating any incorrect or outdated data.

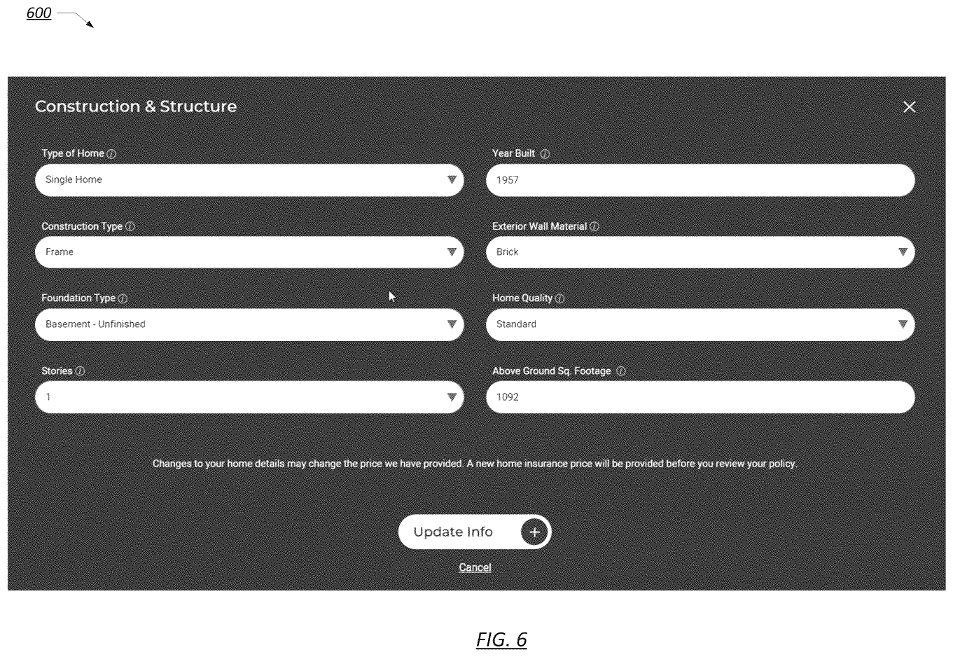

FIG. 6 is a third page of the progressive graphical user interface of FIG. 3. As illustrated, the information is personal information frequently used to obtain a home policy quote. Any updates that are potentially needed can be edited by the client. Selecting a field enables the user to edit the information that was retrieved, updating any incorrect or outdated data.

As depicted, page (600) is displayed in response to a selection of a control element on page (500) for editing the pre-populated data. Clicking one of the control elements from page (500) brings the user to page (600), where the user may amend the prepopulated data. in some embodiments, page 600 may be displayed as a subsequent page in a page sequence of the graphical user interface, or as an overlay or a pop-up atop page (500).

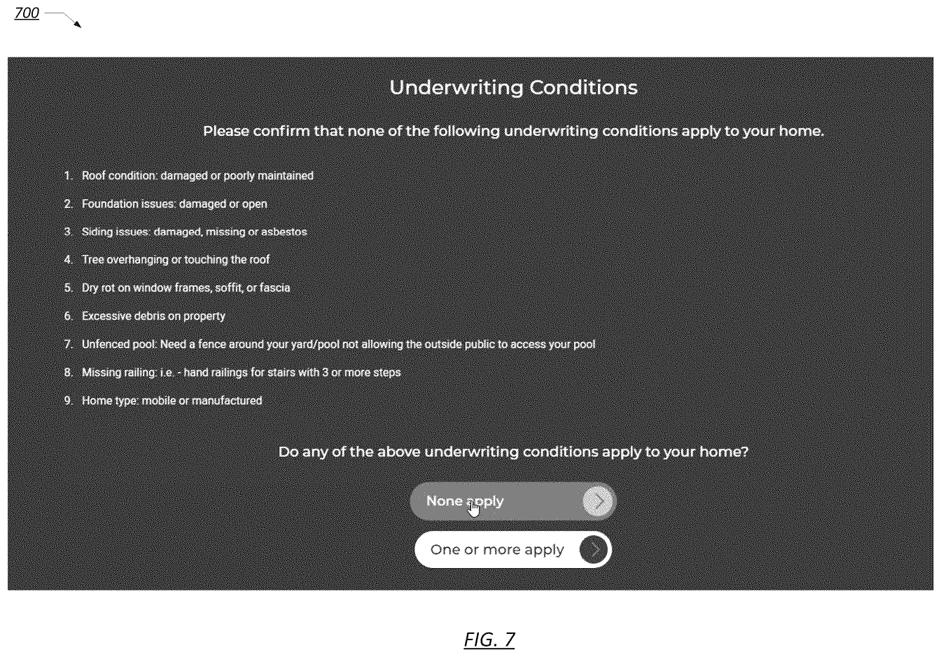

As illustrated in FIG. 7-21, the progressive graphical user interface enables a user to add different riders and/or endorsements to the policy. Different carriers may have a unique way to name these riders or endorsements, such as “discount rider” or “bundling endorsement”, but the concept is the same. these riders or endorsements modify the policy with additional benefits or discounts for the policyholder. Each policy and each company may have different rules and forms of endorsements or riders, and some may require the policyholder to meet certain criteria or conditions to qualify for the discounts.

Endorsements are added to the policy after it has been issued, and they are usually in the form of a rider or amendment that is attached to the original policy. Policy endorsements are usually used to modify coverage and adjust the policy to the policyholder's specific needs. They can be either automatic or require the underwriting approval of the insurance company.

A rider, on the other hand, is a separate document that is added to the policy and is used to provide additional coverage or modify existing coverage. It is a standalone document that provides additional coverage or modifies existing coverage. A rider may be used to add coverage for specific risks or situations that were not included in the original policy, or to adjust the policy to reflect a change in the policyholder's circumstances.

Examples of types of endorsements include adding or removing a named insured, changing the policy limits, adding or removing coverage for specific perils, adding or removing a coverage for a specific location, and/or changing the policy deductibles.

For example, a policyholder may have a basic home insurance policy, but they may want to add coverage for specific risks such as flooding or earthquakes, which are not typically covered under a standard home insurance policy. In this case, the policyholder can add a rider or endorsement to their policy to provide coverage for these specific risks.

Additionally, a policyholder may want to add additional coverage options such as personal liability protection, umbrella coverage, or identity theft protection to their existing policy, this can be added as a rider or endorsement as well. optional discounts or bundle options can also be added as riders or endorsements to an existing insurance policy. Bundling multiple policies, such as home and auto insurance, with the same insurance company can also qualify for a discount, this can be added as a rider or endorsement as well.

For example, a policyholder may be eligible for a discount on their auto insurance policy if they have multiple vehicles insured with the same company, or if they have taken a defensive driving course. In this case, the policyholder can add a rider or endorsement to their policy to reflect the discount.

FIG. 7 is a fourth page of the progressive graphical user interface of FIG. 3. Page (700) may be displayed when the policy and/or carrier has coverage rules, criteria and/or conditions that the policyholder must meet certain to qualify for coverage and/or discounts. Page (700) may solicit a response confirming applicability of one or more of the coverage rules, criteria, and or conditions.

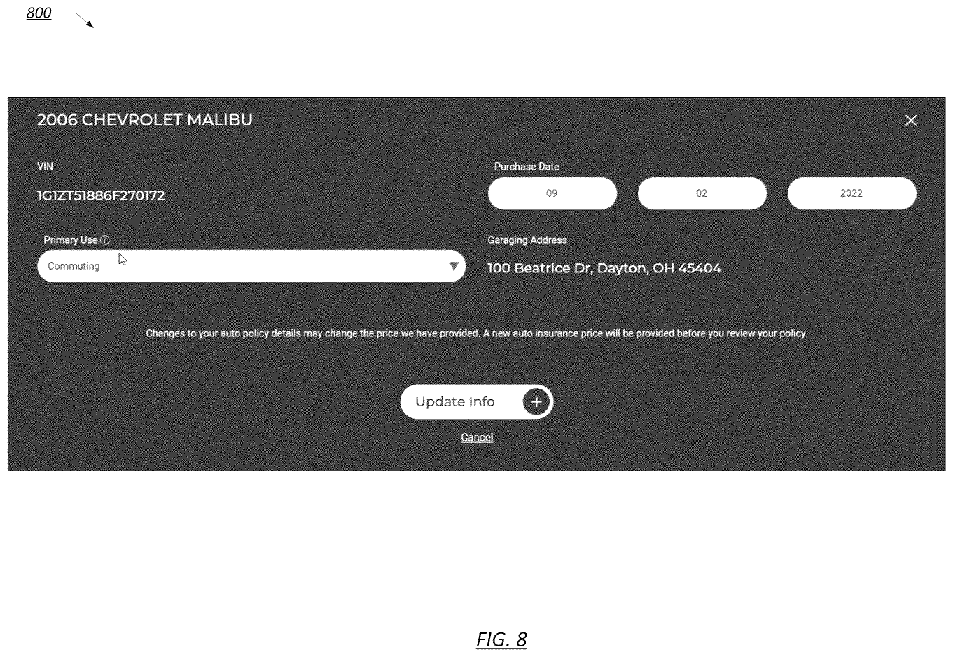

FIG. 8 is a fifth page of the progressive graphical user interface of FIG. 3. As depicted, page (800) provides an overview of home coverage of a quoted policy from a particular carrier. Suggested coverage amount, deductibles, as well as suggested riders and/or endorsements are populated into the various fields of page (800). As illustrated, the information is about a user's home. Any updates that are potentially needed can be edited by the user. Selecting a field enables the user to edit the suggested information, updating any incorrect or outdated data.

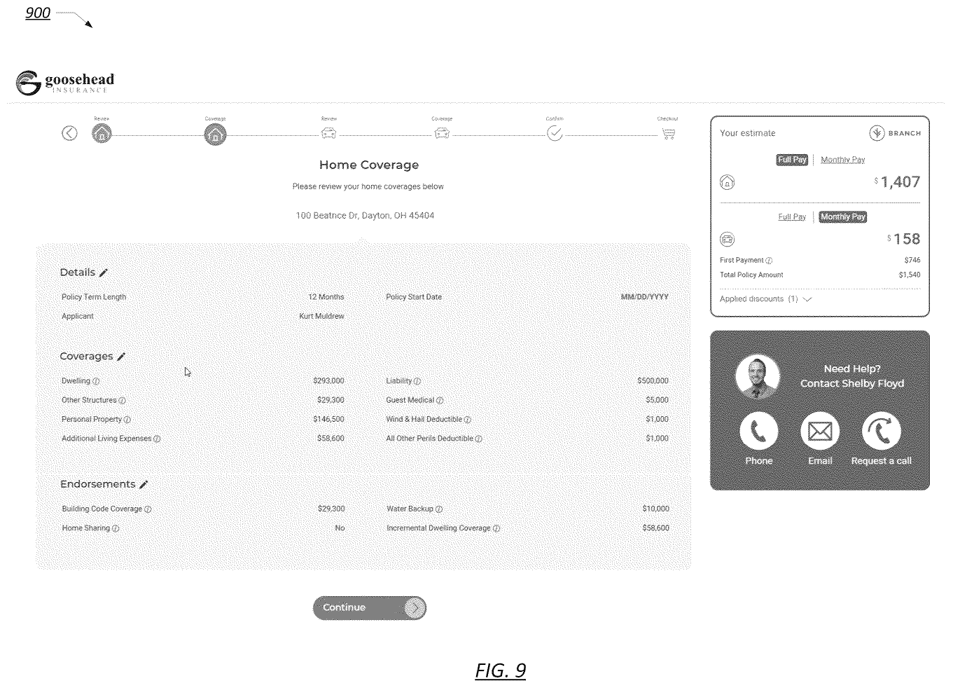

FIG. 9 is a sixth page of the progressive graphical user interface of FIG. 3. Updates that are potentially needed can be edited by the client. As depicted, page (900) enables a user to confirm policy start dates and/or policy durations.

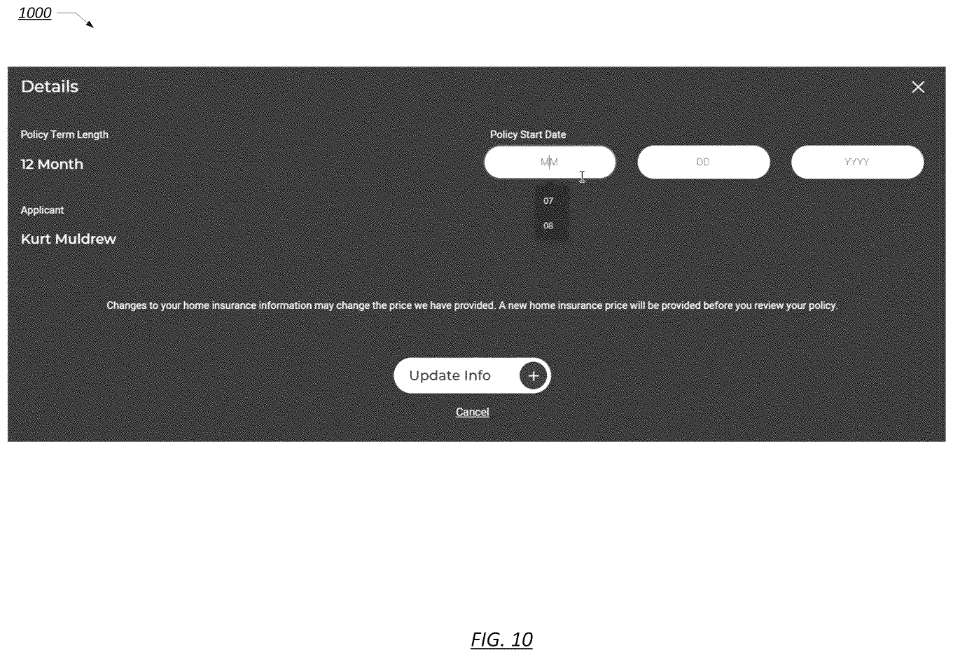

FIG. 10 is a seventh page of the progressive graphical user interface of FIG. 3. Suggested coverage amount, deductibles, as well as suggested riders and/or endorsements are populated into the various fields of page (1000).

As depicted, page (1000) is displayed in response to a selection of a control element on page (800) for editing the pre-populated data. Clicking one of the control elements from page (800) brings the user to page (1000), where the user may amend the suggested coverages. in some embodiments, page (1000) may be displayed as a subsequent page in a page sequence of the graphical user interface, or as an overlay or a pop-up atop page (800).

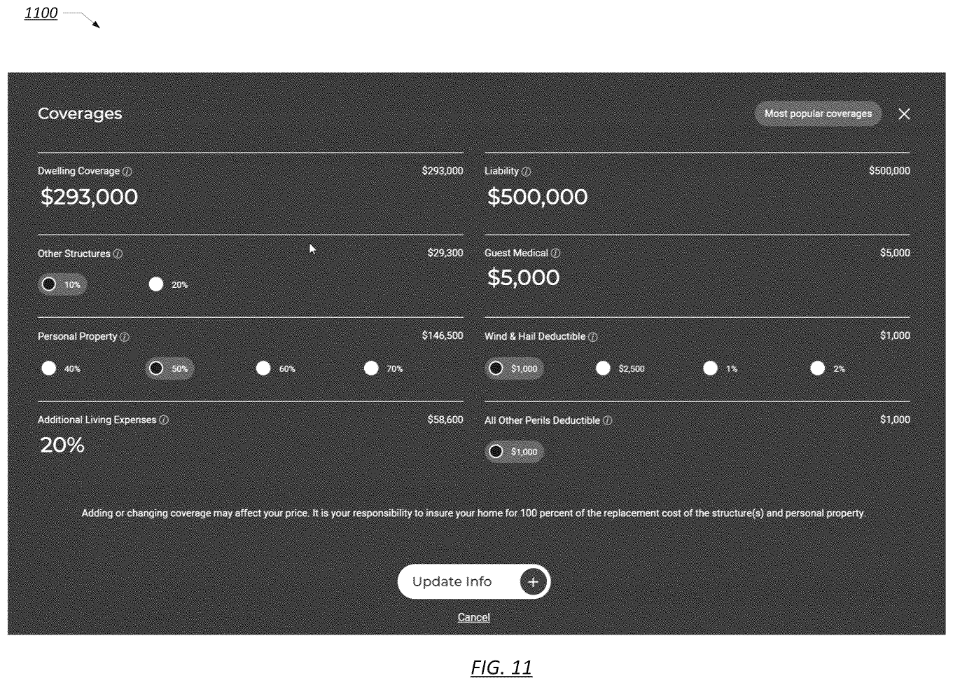

FIG. 11 is an eighth page of the progressive graphical user interface of FIG. 3. Information can be pulled from a third-party data source, such as one of the data sources (130) of FIG. 1, and can be populated into the various fields of page (1100). As illustrated, the information is personal information frequently used to obtain an auto policy quote. Any updates that are potentially needed can be edited by the client. Selecting a field enables the user to edit the information that was retrieved, updating any incorrect or outdated data.

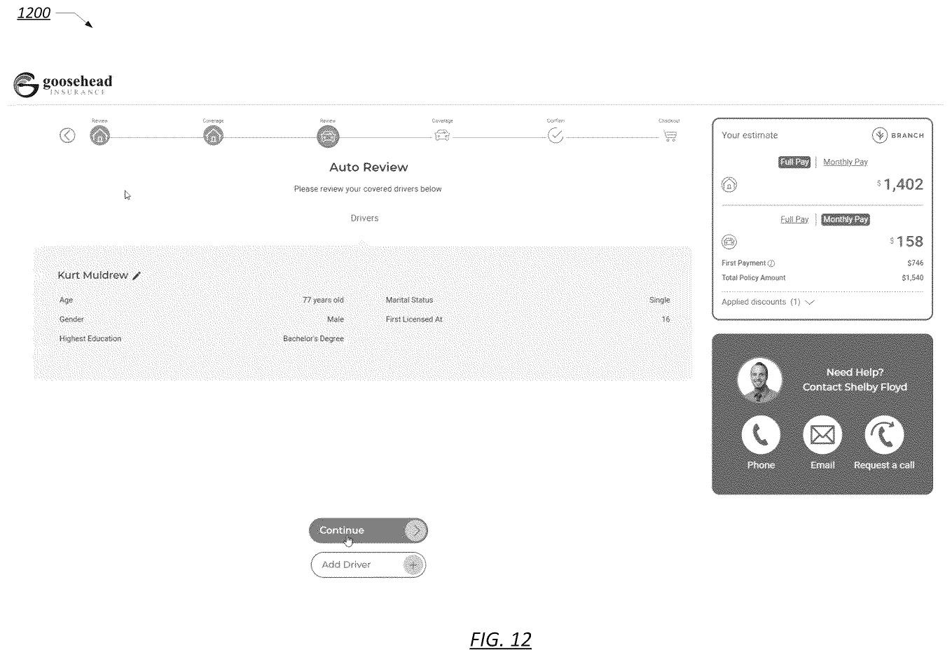

FIG. 12 is a ninth page of the progressive graphical user interface of FIG. 3. As illustrated, the information is personal information frequently used to obtain an auto policy quote. Any updates that are potentially needed can be edited by the client. Selecting a field enables the user to edit the information that was retrieved, updating any incorrect or outdated data.

As depicted, page (1200) is displayed in response to a selection of a control element on page (1100) for editing the pre-populated data. Clicking one of the control elements from page (1100) brings the user to page (1200), where the user may amend the prepopulated data. in some embodiments, page (1200) may be displayed as a subsequent page in a page sequence of the graphical user interface, or as an overlay or a pop-up atop page (1100).

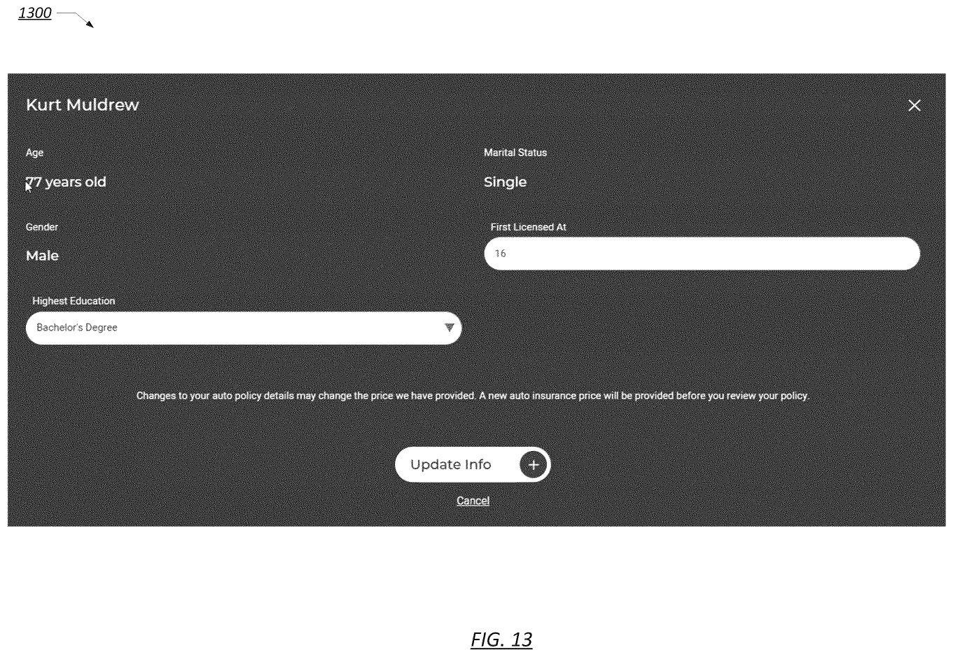

FIG. 13 is a tenth page of the progressive graphical user interface of FIG. 3. Information can be pulled from a third-party data source, such as one of the data sources (130) of FIG. 1, and can be populated into the various fields of page (1100). As illustrated, the information is vehicle information frequently used to obtain an auto policy quote. Any updates that are potentially needed can be edited by the client. Selecting a field enables the user to edit the information that was retrieved, updating any incorrect or outdated data.

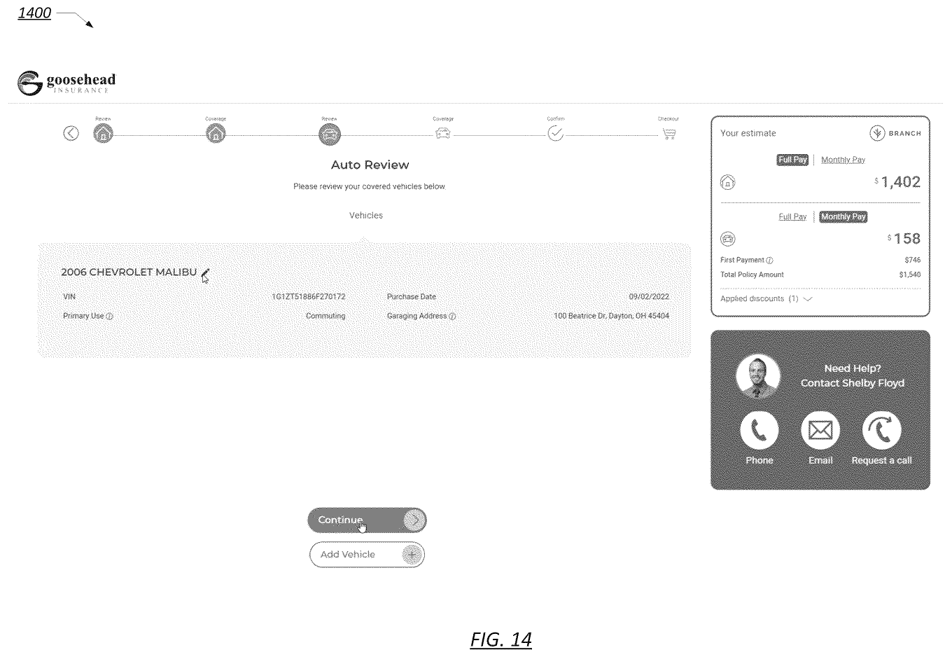

FIG. 14 is an eleventh page of the progressive graphical user interface of FIG. 3. As illustrated, the information is vehicle information frequently used to obtain an auto policy quote. Any updates that are potentially needed can be edited by the client. Selecting a field enables the user to edit the information that was retrieved, updating any incorrect or outdated data.

As depicted, page (1400) is displayed in response to a selection of a control element on page (1300) for editing the pre-populated data. Clicking one of the control elements from page (1300) brings the user to page (1400), where the user may amend the prepopulated data. in some embodiments, page (1400) may be displayed as a subsequent page in a page sequence of the graphical user interface, or as an overlay or a pop-up atop page (1300).

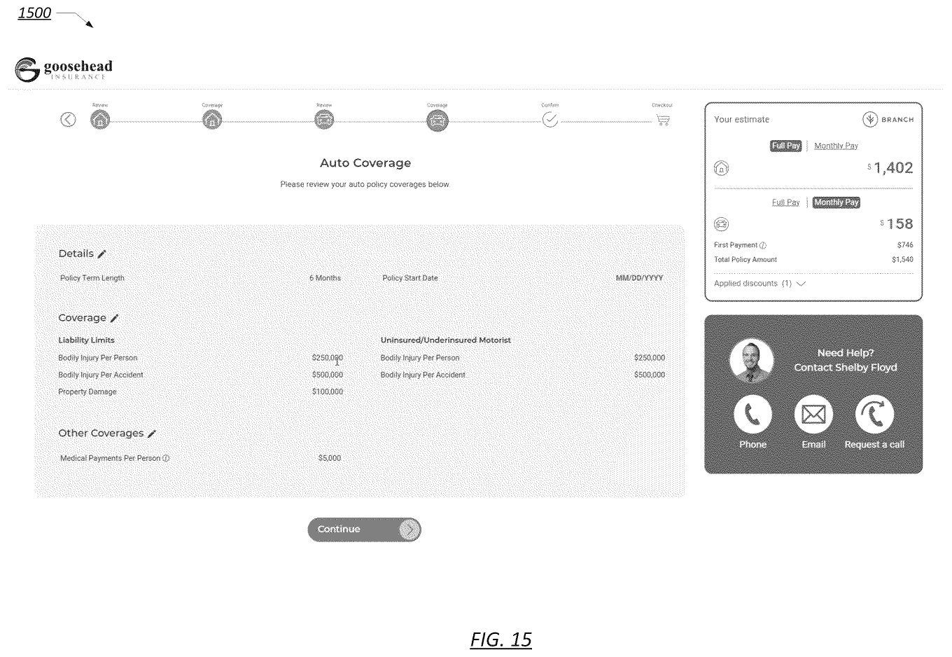

FIG. 15 is a twelfth page of the progressive graphical user interface of FIG. 3. As depicted, page (1500) provides an overview of auto coverage of a quoted policy from a particular carrier. Suggested coverage amount, deductibles, as well as suggested riders and/or endorsements are populated into the various fields of page (1500). As illustrated, the information is about a user's home. Any updates that are potentially needed can be edited by the user. Selecting a field enables the user to edit the suggested information, updating any incorrect or outdated data.

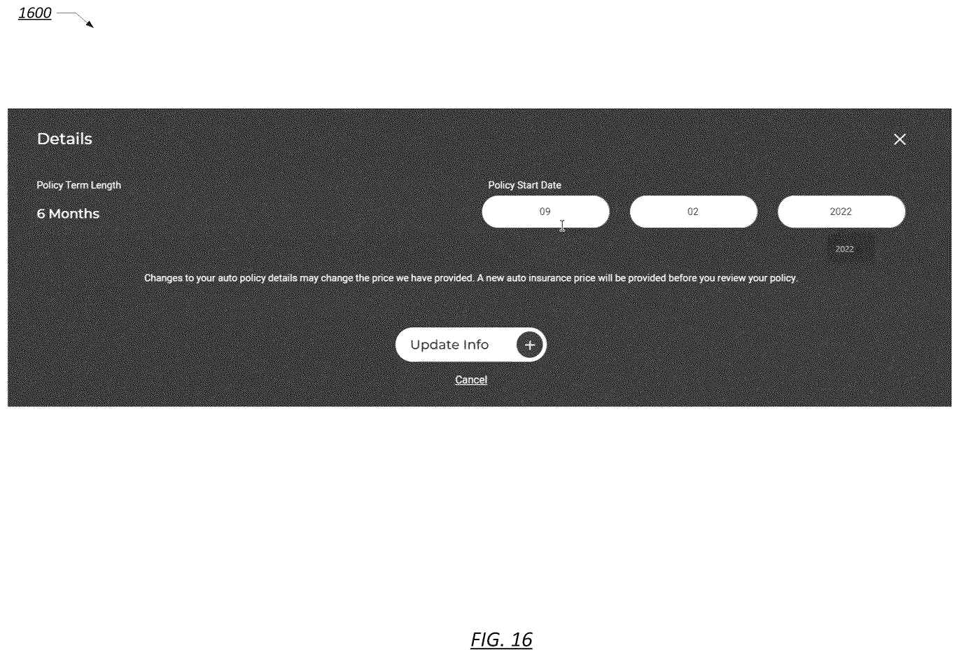

FIG. 16 is a thirteenth page of the progressive graphical user interface of FIG. 3. Updates that are potentially needed can be edited by the client. As depicted, page (1600) enables a user to confirm policy start dates and/or policy durations.

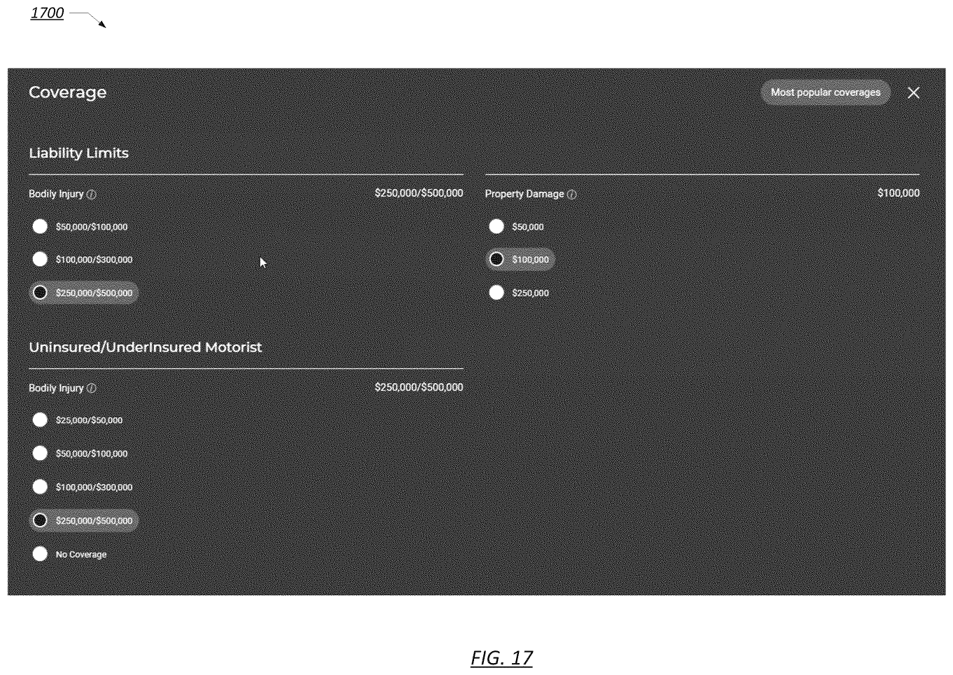

FIG. 17 is a fourteenth page of the progressive graphical user interface of FIG. 3. Suggested coverage amount, deductibles, as well as suggested riders and/or endorsements are populated into the various fields of page (1700).

As depicted, page (1700) is displayed in response to a selection of a control element on page (1500) for editing the pre-populated data. Clicking one of the control elements from page (1500) brings the user to page (1700), where the user may amend the suggested coverages. in some embodiments, page (1700) may be displayed as a subsequent page in a page sequence of the graphical user interface, or as an overlay or a pop-up atop page (1500).

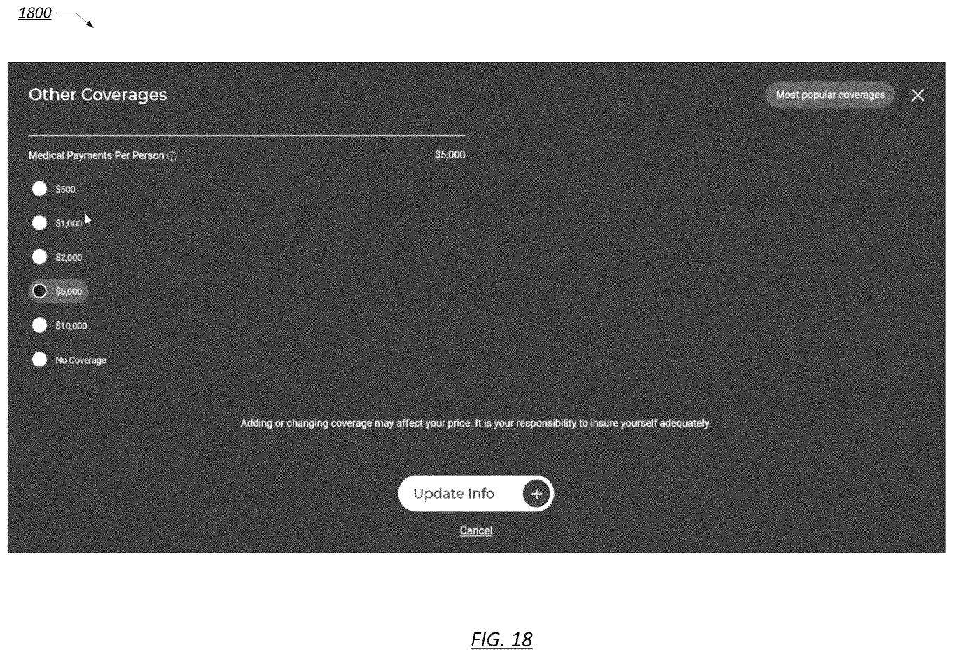

FIG. 18 is a fifteenth page of the progressive graphical user interface of FIG. 3. Suggested coverage amount, deductibles, as well as suggested riders and/or endorsements are populated into the various fields of page (1800).

As depicted, page (1800) is displayed in response to a selection of a control element on page (1500) for editing the pre-populated data. Clicking one of the control elements from page (1500) brings the user to page (1800), where the user may amend the suggested coverages. in some embodiments, page (1800) may be displayed as a subsequent page in a page sequence of the graphical user interface, or as an overlay or a pop-up atop page (1500).

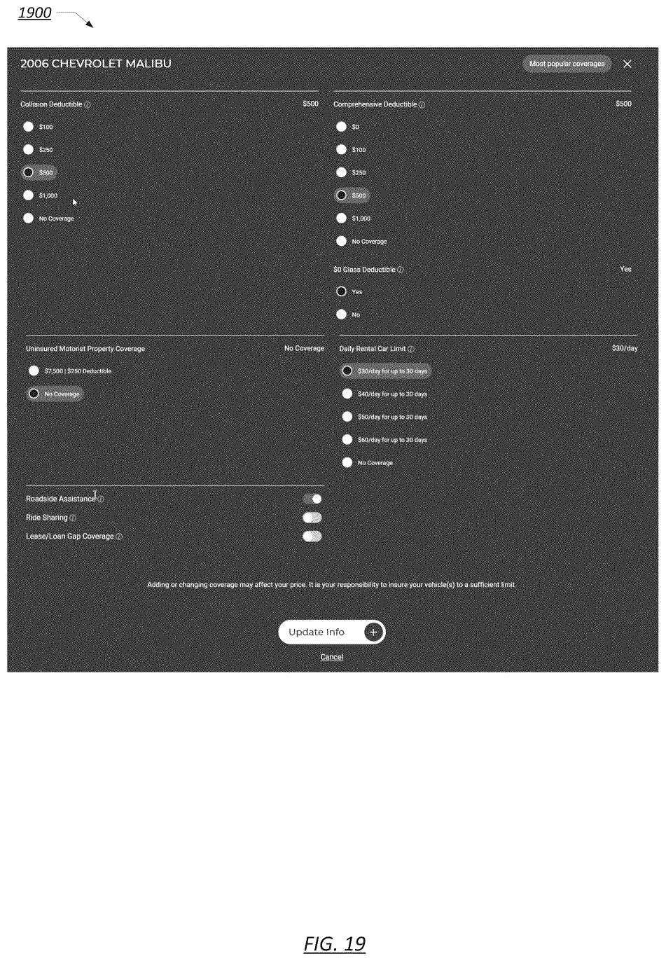

FIG. 19 is a sixteenth page of the progressive graphical user interface of FIG. 3. Suggested coverage amount, deductibles, as well as suggested riders and/or endorsements are populated into the various fields of page (1900).

As depicted, page (1900) is displayed in response to a selection of a control element on page (1500) for editing the pre-populated data. Clicking one of the control elements from page (1500) brings the user to page (1900), where the user may amend the suggested coverages. in some embodiments, page (1900) may be displayed as a subsequent page in a page sequence of the graphical user interface, or as an overlay or a pop-up atop page (1500).

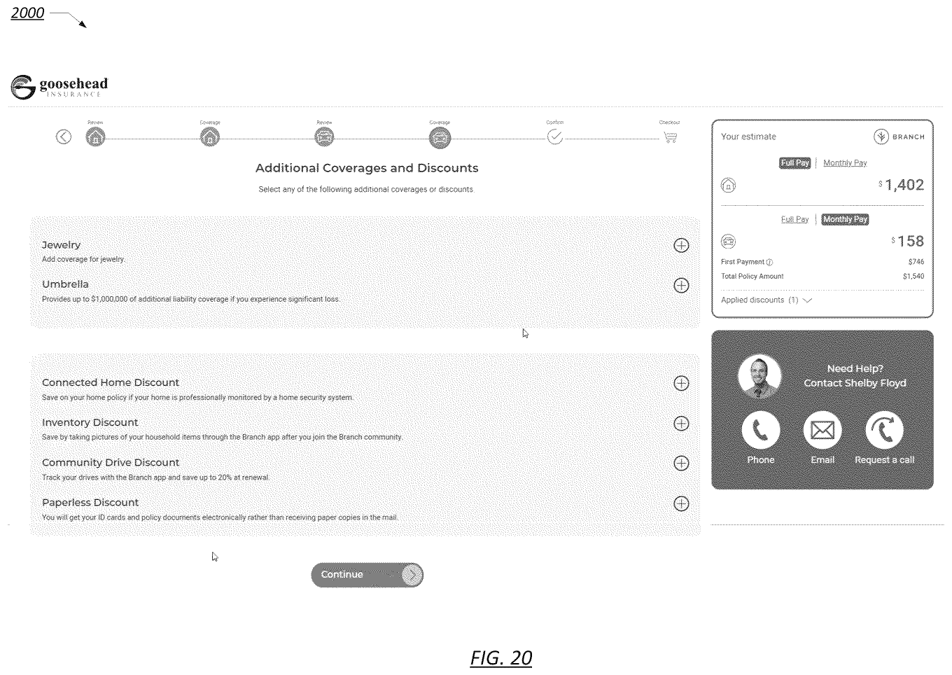

FIG. 20 is a seventeenth page of the progressive graphical user interface of FIG. 3. One or more of pages (2000) may enable the user to add discounts and additional coverages for specific carrier riders and/or endorsements. For example, a carrier may offer a jewelry endorsement and an umbrella endorsement that are automatically added based on options selected and information submitted by the user. Selection of a different coverage option may remove any of these carrier-specific discounts that were automatically accounted for when preparing the quote.

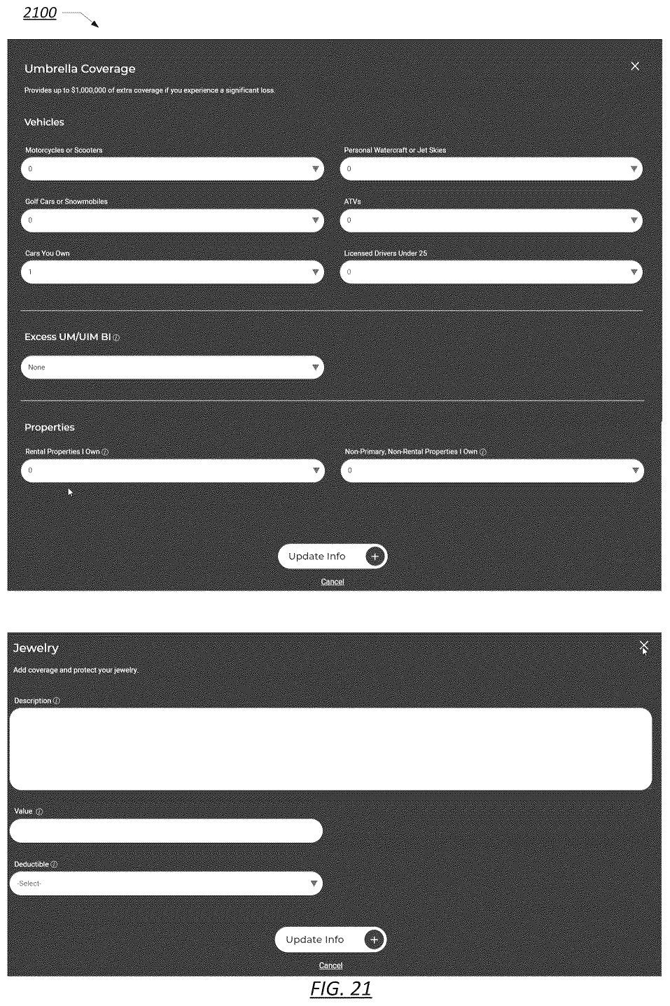

FIG. 21 is an eighteenth page of the progressive graphical user interface of FIG. 3. Suggested coverage amount, deductibles, as well as suggested riders and/or endorsements are populated into the various fields of page (2100).

As depicted, page (2100) is displayed in response to a selection of a control element on page (1500) for editing the pre-populated data. Clicking one of the control elements from page (1500) brings the user to page (2100), where the user may amend the suggested coverages. in some embodiments, page (2100) may be displayed as a subsequent page in a page sequence of the graphical user interface, or as an overlay or a pop-up atop page (1500).

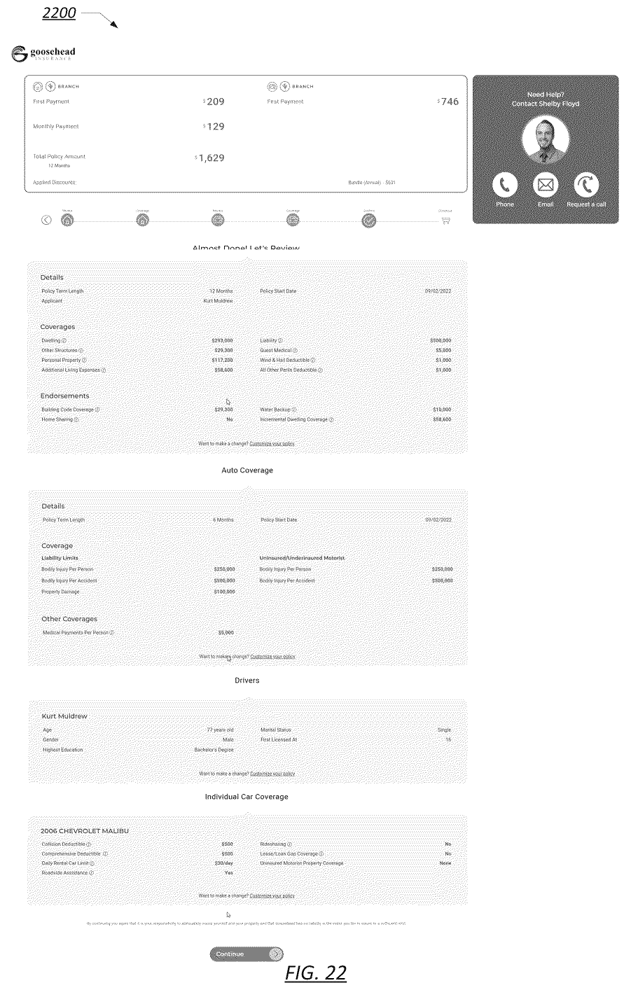

FIG. 22 is a nineteenth page of the progressive graphical user interface of FIG. 3. Page (2200) provides a digital overview of the policy document. This document contains details of the coverage, including the policyholder's personal information, coverage limits, exclusions, and other valuable information. In some embodiments, page (2200) may provide a list of the material obligations for the policy, which when issued, the parties are legally bound to fulfill.

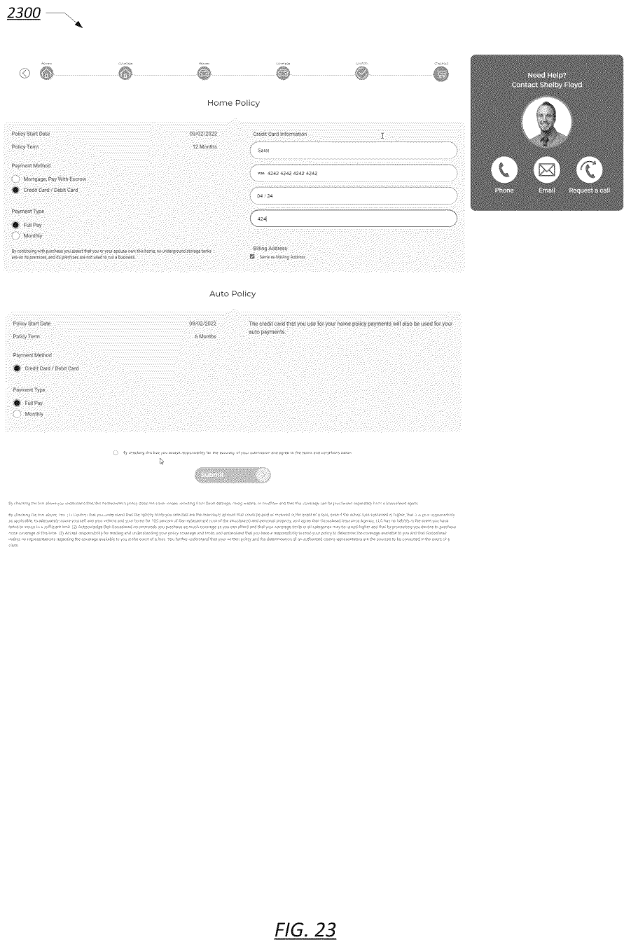

FIG. 23 is a twentieth page of the progressive graphical user interface of FIG. 3. Page 23 may additionally include a payment screen for each carrier. Each carrier may have their own carrier-approved payment options that if accepted, are specifically integrated with the carrier's payment source. For example, each carrier utilize one or more different 3rd party payment portals to integrate payment functionality into the applications, such as PayPal, Stripe, Square, Braintree, etc. Each portal may have its own specific APIs to process payments, manage transactions, and manage customer information securely. Each API may support a wide range of payment methods, including credit and debit cards, bank transfers, and mobile payments.

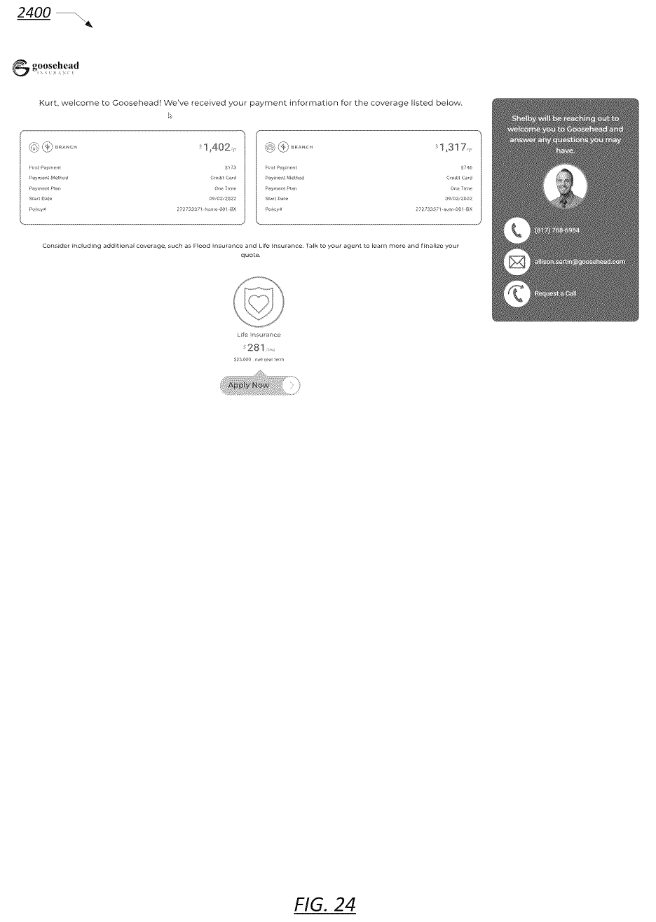

In this manner, the carrier-specific page may also be customized, for example, giving the user an option to pay through a financial institution or with credit card depending on the carrier. The bind process begins when payment is sent. Policy numbers can be received from the carrier and displayed in a subsequent page of the graphical user interface and displayed when the policy is bound. A confirmation page, such as page (2400) of FIG. 24, can be displayed that confirms the payment type and payment amount, as well as policy information such as a start date and policy numbers.

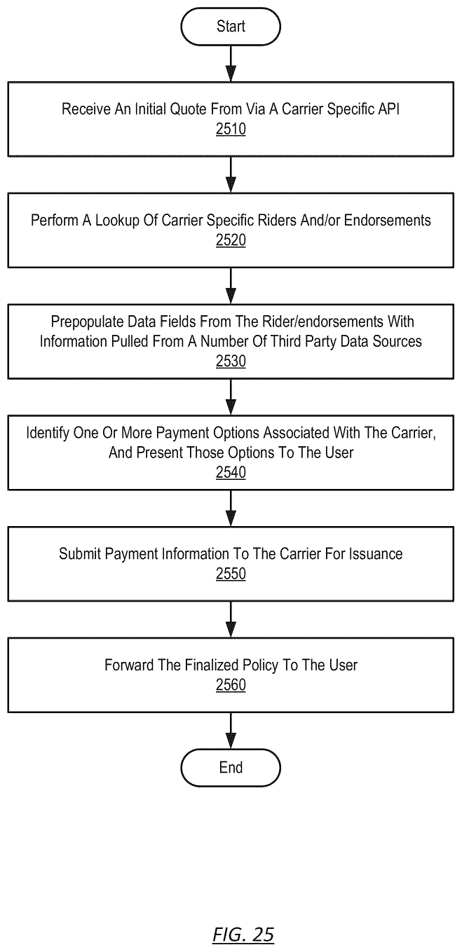

Referring now to FIG. 25, a flow chart of a process for an electronic transaction to bind an insurance policy is shown according to illustrative embodiments. The process of FIG. 25 can be implemented in one or more components of FIGS. 1-3 comma such as QTI application (X).

At step (2510), the process receives an initial quote from via a carrier specific API. At step (2520), the process performs a lookup of carrier specific riders and/or endorsements. data fields from the rider/endorsements are prepopulated with information pulled from a number of third-party data sources at step (2530). Upon receiving confirmation of the finalized quote from the user, the process identifies one or more payment options associated with the carrier, and presents those options to the user at step (2540). The process then submits payment information to the carrier for issuance of the policy at step (2550). After the payment is processed, the carrier generates an issued policy, which is submitted back to the QTI application. Upon receipt of the policy, the process forwards the finalized policy to the user at step (2560). The process terminates thereafter.

While the various steps in this flowchart are presented and described sequentially, at least some of the steps may be executed in different orders, may be combined, or omitted, and at least some of the steps may be executed in parallel. Furthermore, the steps may be performed actively or passively.

The following example is for explanatory purposes only and not intended to limit the scope of the invention.

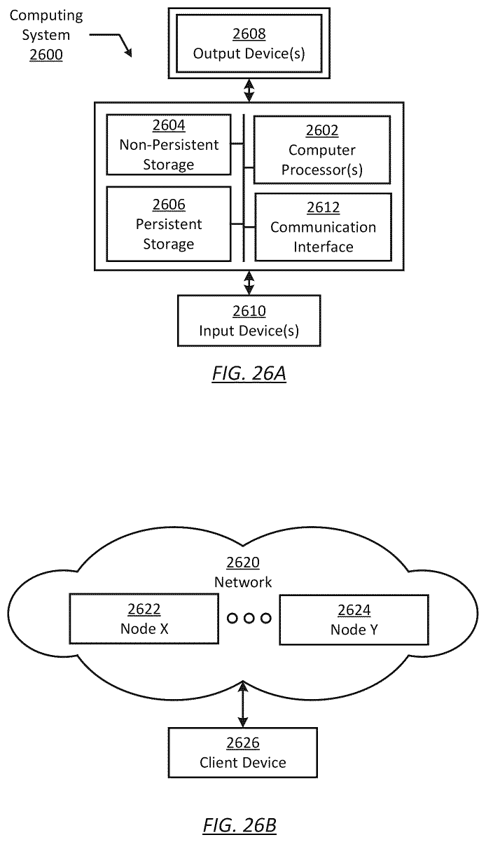

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 26A, the computing system (2600) may include one or more computer processors (2602), non-persistent storage (2604), persistent storage (2606), a communication interface (2612) (e.g., Bluetooth interface, infrared interface, network interface, optical interface, etc.), and numerous other elements and functionalities that implement the features and elements of the disclosure. The computer processor(s) (2602) may be an integrated circuit for processing instructions. The computer processor(s) may be one or more cores or micro-cores of a processor. The computer processor(s) (2602) includes one or more processors. The one or more processors may include a central processing unit (CPU), a graphics processing unit (GPU), a tensor processing unit (TPU), combinations thereof, etc.

The input devices (2610) may include a touchscreen, keyboard, mouse, microphone, touchpad, electronic pen, or any other type of input device. The input devices (2610) may receive inputs from a user that are responsive to data and messages presented by the output devices (2608). The inputs may include text input, audio input, video input, etc., which may be processed and transmitted by the computing system (2600) in accordance with the disclosure. The communication interface (2612) may include an integrated circuit for connecting the computing system (2600) to a network (not shown) (e.g., a local area network (LAN), a wide area network (WAN) such as the Internet, mobile network, or any other type of network) and/or to another device, such as another computing device.

Further, the output devices (2608) may include a display device, a printer, external storage, or any other output device. One or more of the output devices may be the same or different from the input device(s). The input and output device(s) may be locally or remotely connected to the computer processor(s) (2602). Many diverse types of computing systems exist, and the aforementioned input and output device(s) may take other forms. The output devices (2608) may display data and messages that are transmitted and received by the computing system (2600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (2600) in FIG. 26A may be connected to or be a part of a network. For example, as shown in FIG. 26B, the network (2620) may include multiple nodes (e.g., node X (2622), node Y (2624)). Each node may correspond to a computing system, such as the computing system shown in FIG. 26A, or a group of nodes combined may correspond to the computing system shown in FIG. 26A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (2600) may be located at a remote location and connected to the other elements over a network.

The nodes (e.g., node X (2622), node Y (2624)) in the network (2620) may be configured to provide services for a client device (2626), including receiving requests and transmitting responses to the client device (2626). For example, the nodes may be part of a cloud computing system. The client device (2626) may be a computing system, such as the computing system shown in FIG. 26A. Further, the client device (2626) may include and/or perform all or a portion of one or more embodiments of the invention.

The computing system of FIG. 26A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A computer-implemented method for issuing an insurance policy, the method comprising:
displaying, on a user interface, a confirmation page for a user to confirm or edit coverage details;
upon receiving confirmation of the coverage details, recalculating, via an application programming interface (API), the insurance quote based on the confirmed coverage details and the mortgage information;
displaying a payment screen for the user to select a payment method;
upon selection of a payment method, generating a payment token based on the entered payment details;
sending, via the API, the recalculated quote for binding the insurance policy;
receiving a policy number from an insurance provider system;
storing the received policy number in a database; and
updating customer relationship management (CRM) data with the policy information, property, driver, vehicle details, the policy number, and the bound status of the insurance policy.

2. The method of claim 1, wherein the confirmation page is displayed in response to a submission received from the user indicating a request for an insurance quote.

3. The method of claim 1, wherein the payment screen is configured to allow the user to select between multiple payment methods and to enter credit card information for payment processing.

4. The method of claim 1, wherein the mortgage information is pulled from a third-party database via the API.

5. The method of claim 1, further comprising:
updating the database with the user's selected payment method; and
recalculating the insurance quote if the user edits the coverage details.

6. The method of claim 1, wherein the generation of the payment token includes encryption of the payment details for secure transmission to a payment processor.

7. The method of claim 1, wherein the CRM is updated in real-time in response to receiving the policy number from the insurance provider system.

8. A system for issuing an insurance policy, the system comprising:
a processor;
a user interface configured to display insurance policy options and receive user inputs;
an API configured to communicate with external data sources and insurance provider systems for quote recalculations and policy bindings; and
a database configured to store policy numbers, user details, and bound status of issued insurance policies,
memory storing instructions that, when executed by the processor, cause the system to perform the method of:
displaying, on a user interface, a confirmation page for a user to confirm or edit coverage details;
upon receiving confirmation of the coverage details, recalculating, via an application programming interface (API), the insurance quote based on the confirmed coverage details and the mortgage information;
displaying a payment screen for the user to select a payment method;
upon selection of a payment method, generating a payment token based on the entered payment details;
sending, via the API, the recalculated quote for binding the insurance policy;
receiving a policy number from an insurance provider system;
storing the received policy number in a database; and
updating customer relationship management (CRM) data with the policy information, property, driver, vehicle details, the policy number, and the bound status of the insurance policy.

9. The method of claim 8, wherein the confirmation page is displayed in response to a submission received from the user indicating a request for an insurance quote.

10. The method of claim 8, wherein the payment screen is configured to allow the user to select between multiple payment methods and to enter credit card information for payment processing.

11. The method of claim 8, wherein the mortgage information is pulled from a third-party database via the API.

12. The method of claim 8, further comprising:
updating the database with the user's selected payment method; and
recalculating the insurance quote if the user edits the coverage details.

13. The method of claim 8, wherein the generation of the payment token includes encryption of the payment details for secure transmission to a payment processor.

14. The method of claim 8, wherein the CRM is updated in real-time in response to receiving the policy number from the insurance provider system.

15. A graphical user interface (GUI) for issuing an insurance policy displayed on a client device, the interface comprising:
a plurality of user-interactive fields to receive input for property and vehicle details for insurance coverage;
a confirmatory screen page prompting user validation of the inputted insurance coverage details;
a payment interface page configured to accept a user's selection of a payment method;
a mortgage information interface page configured to receive user input relating to mortgage details pertinent to the insurance policy; and
a final review interface page configured to display a summary of the insurance policy details for final user confirmation.

16. The GUI of claim 15, wherein the confirmatory screen page allows for editing of the inputted insurance coverage details and triggers a recalculation of an insurance quote.

17. The GUI of claim 15, wherein the payment interface page includes a credit card input field, a confirmation action element, and an API to generate a secure payment token.

18. The GUI of claim 15, further comprising:
a discount and additional coverage interface page that presents a selection of discounts and additional coverages available to the user;
wherein selection of a discount or additional coverage triggers a recalculation of the insurance quote.

19. The GUI of claim 15, further comprising:
an update interface page that communicates with a backend application programming interface (API) to retrieve and display updated mortgage information.

20. The GUI of claim 15, further comprising:
an issuance interface page configured to display a bound status of the insurance policy once the policy is issued.
